(19) United States
(12) Patent Application Publication
(10) Pub. No.: US 2026/0074333 A1
(43) Pub. Date: Mar. 12, 2026

(54) SECONDARY BATTERY AND BATTERY PACK INCLUDING THE SECONDARY BATTERY

(71) Applicant: SAMSUNG SDI CO., LTD., Yongin-si (KR)

(72) Inventor: Ji Won YUN, Yongin-si (KR)

(21) Appl. No.: 19/278,959

(22) Filed: Jul. 24, 2025

(30) Foreign Application Priority Data
Sep. 12, 2024 (KR) 10-2024-0124908

(51) Int. Cl. H01M 50/184; F16J 15/08; H01M 50/107; H01M 50/145; H01M 50/167; H01M 50/186; H01M 50/213

(52) U.S. Cl. CPC H01M 50/184; F16J 15/0818; H01M 50/107; H01M 50/145; H01M 50/167; H01M 50/186; H01M 50/213

(57) ABSTRACT

A secondary battery includes a case having an opening portion formed therein, an electrode assembly accommodated in the case, a cap assembly closing the opening portion, and a crimping part extending from the case and surrounding the cap assembly. A first gasket is disposed between the cap assembly and the crimping part, and a second gasket extends from the first gasket and protrudes outward from the crimping part.

### CROSS-REFERENCE TO RELATED APPLICATION

The present application claims priority to and the benefit of Korean Patent Application No. 10-2024-0124908, filed on Sep. 12, 2024, in the Korean Intellectual Property Office, the entire disclosure of which is incorporated herein by reference.

### BACKGROUND

### 1. Field of the Disclosure

The present disclosure relates to a secondary battery and a battery pack including the secondary battery.

### 2. Discussion of Related Art

The demand for secondary batteries with high energy density and capacity has recently increased with the rapid use of electronic apparatuses that include batteries, such as portable phones, notebook computers, and electric vehicles. Accordingly, research and development for improving performance of lithium secondary batteries are actively being conducted.

Lithium secondary batteries include positive electrodes and negative electrodes that have active materials capable of intercalation and deintercalation of lithium ions and electrolytes. Secondary batteries produce electric energy through oxidation and reduction reactions when the lithium ions are intercalated/deintercalated at the positive electrodes and negative electrodes.

The information disclosed in this background section is provided for enhancement of understanding of the background of the present disclosure. It may contain information that does not constitute related (or prior) art.

### SUMMARY OF THE DISCLOSURE

The present disclosure is directed to providing a secondary battery in which a gasket is shaped so that its sealing force is increased and leakage is prevented, with the gasket having a crimping part protruding outward to prevent rust generation of an end portion of the crimping part, and a battery pack including the secondary battery.

These and other aspects and features of the present disclosure will be described in or will be apparent from the following description of some embodiments of the present disclosure.

According to one aspect of the present disclosure, there is provided a secondary battery including a case having an opening portion formed therein, an electrode assembly accommodated in the case, a cap assembly closing the opening portion, a crimping part extending from the case and surrounding the cap assembly, a first gasket disposed between the cap assembly and the crimping part, and a second gasket extending from the first gasket and protruding from the crimping part.

The first gasket may include two surfaces surrounding an end portion of the cap assembly.

The second gasket may be spaced apart from the cap assembly and may be in contact with an end portion of the crimping part.

A height of the second gasket may be greater than a height of the first gasket.

The first gasket may further include an accommodation groove in which the end portion of the crimping part is accommodated.

The accommodation groove may include an inclined accommodation surface inclined downward from an upper surface of the first gasket and toward the second gasket and a vertical accommodation surface vertically extending from an end portion of the inclined accommodation surface.

A height of the second gasket may be greater than a height of the end portion of the crimping part accommodated in the accommodation groove.

The second gasket may further include a close-contact protrusion that spaces the second gasket apart from the cap assembly.

The close-contact protrusion may include a curved surface that is in contact with the cap assembly.

The first gasket may include an accommodation groove in which the end portion of the crimping part is accommodated.

The first gasket may include an accommodation groove in which the end portion of the crimping part is accommodated.

The second gasket may include a first close-contact protrusion in contact with the cap assembly and a second close-contact protrusion that is spaced apart from the first close-contact protrusion and is in contact with the cap assembly.

A height of the first close-contact protrusion may be less than a height of the second close-contact protrusion.

Each of the first close-contact protrusion and the second close-contact protrusion may be hemisphere shaped.

A height of the first close-contact protrusion may be 0.1 mm, and a height of the second close-contact protrusion may be 0.15 mm.

A distance between the first close-contact protrusion and the second close-contact protrusion may be 1 mm to 2 mm.

The first gasket may include an accommodation groove in which the end portion of the crimping part is accommodated.

The first gasket and the second gasket may be integrally formed.

According to another aspect of the present disclosure, there is provided a battery pack including a housing, a plurality of secondary batteries disposed in the housing, and a busbar that connects the secondary batteries, wherein each of the secondary batteries includes a case having an opening formed therein, an electrode assembly accommodated in the case, a cap assembly closing the opening, a crimping part extending from the case and surrounding the cap assembly, a first gasket disposed between the cap assembly and the crimping part, and a second gasket extending from the first gasket and protruding from the crimping part.

The first gaskets and the second gaskets may be integrally formed.

### BRIEF DESCRIPTION OF THE DRAWINGS

The drawings attached to this specification illustrate embodiments of the present disclosure, and further describe aspects and features of the present disclosure together with the detailed description of the present disclosure. However, the present disclosure is not limited to the embodiments depicted in the drawings.

FIG. 1 is a schematic perspective view showing a structure of a battery pack according to various embodiments of the present disclosure;

FIG. 2 is a schematic perspective view showing a structure of a secondary battery according to a first embodiment of the present disclosure;

FIG. 3 is a schematic cross-sectional view showing the structure of the secondary battery according to the first embodiment of the present disclosure;

FIG. 4 is a schematic enlarged view showing a structure of a cap assembly according to the first embodiment of the present disclosure;

FIG. 5 is a cross-sectional view showing a gasket according to the first embodiment of the present disclosure;

FIG. 6 is an enlarged view illustrating the cap assembly, to which the gasket is applied, according to the first embodiment of the present disclosure;

FIG. 7 is an enlarged view showing an accommodation groove according to the first embodiment of the present disclosure;

FIG. 8 is a view for describing an operation of the gasket due to crimping according to the first embodiment of the present disclosure;

FIG. 9 is a cross-sectional view showing a gasket according to a second embodiment of the present disclosure;

FIG. 10 is an enlarged view illustrating a cap assembly, to which the gasket is applied, according to the second embodiment of the present disclosure;

FIG. 11 is an enlarged view showing a close-contact protrusion according to the second embodiment of the present disclosure;

FIG. 12 is a view for describing an operation of the gasket due to crimping according to the second embodiment of the present disclosure;

FIG. 13 is a view showing a modified example of the close-contact protrusion according to the second embodiment of the present disclosure;

FIG. 14 is a cross-sectional view showing a gasket according to a third embodiment of the present disclosure;

FIG. 15 is an enlarged view illustrating a cap assembly, to which the gasket is applied, according to the third embodiment of the present disclosure;

FIG. 16 is an enlarged view showing a close-contact protrusion according to the third embodiment of the present disclosure; and

FIG. 17 is a view for describing an operation of the gasket due to crimping according to the third embodiment of the present disclosure.

### DETAILED DESCRIPTION OF EXEMPLARY EMBODIMENTS

Herein, embodiments of the present disclosure will be described with reference to the accompanying drawings. The terms or words used in this specification and claims should not be construed as being limited to the usual or dictionary meaning and should be interpreted consistent with the technical idea of the present disclosure and based on the principle that the inventor can be his/her own lexicographer.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure. “Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Numerical ranges disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an element is referred to as being disposed (or located or positioned) on the “above (or below)” or “on (or under)” a component, it may mean that the element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

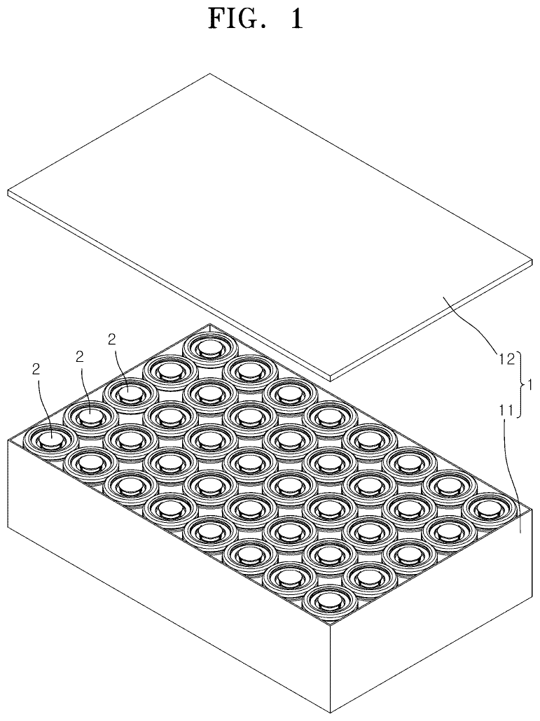

FIG. 1 is a schematic perspective view showing a structure of a battery pack according to various embodiments of the present disclosure.

Referring to FIG. 1, a battery pack according to any of various embodiments includes a housing 1 and a secondary battery 2.

The housing 1 may form an exterior of the battery pack and provide a space in which the secondary battery 2 may be accommodated. The housing 1 according to the present embodiment may include a housing body 11 and a cover 12.

The housing body 11 may be formed as a hollow box with an open side. A cross-sectional shape of the housing body 11 is not limited to the quadrangular shape illustrated in FIG. 1 as the cross-sectional shape of the housing body 11 may be various shapes such as a polygonal shape, a circular shape, and an elliptical shape.

The cover 12 may be coupled to the housing body 11 to close an inner space of the housing body 11. As an example, the cover 12 may be formed in substantially a plate shape and disposed to face an open side of the housing body 11. The cover 12 may be fixed to the housing body 11 through any of various methods such as bolting, welding, and press-fitting.

The secondary battery 2 may serve as a unit structure for storing and supplying power in the battery pack. The secondary battery 2 may be provided as a plurality of secondary batteries 2. The secondary batteries 2 may be disposed to have any of various patterns such as a lattice shape and a zigzag shape in the housing 1. The secondary batteries 2 may be disposed in parallel. The number of the secondary batteries 2 may be variously changed according to a size, a shape, and the like of the housing 1. A detailed structure of the secondary battery will be described below.

The plurality of secondary batteries 2 may be electrically connected through a busbar (not shown). The plurality of secondary batteries 2 may be connected in series or parallel through the busbar. As an example, the busbar may connect the secondary batteries 2 disposed in the same row in the housing 1 and connect the secondary batteries 2 disposed in two adjacent rows. The busbar may be formed of a material through which a current may flow, such as, copper, aluminum, or nickel.

Hereinafter, the structure of the secondary battery according to embodiments of the present disclosure will be described.

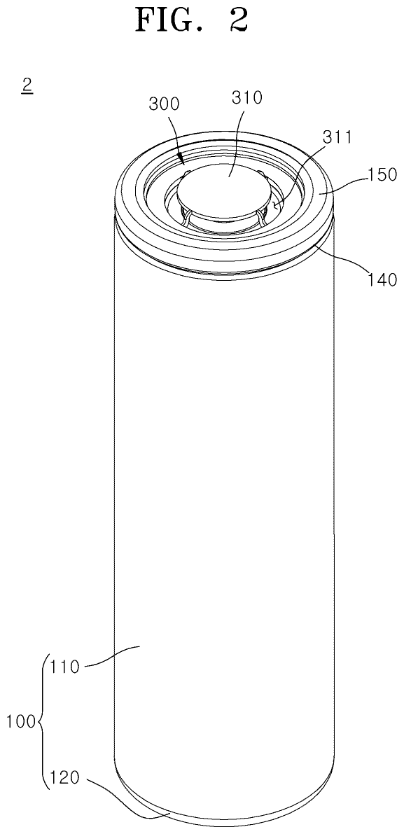

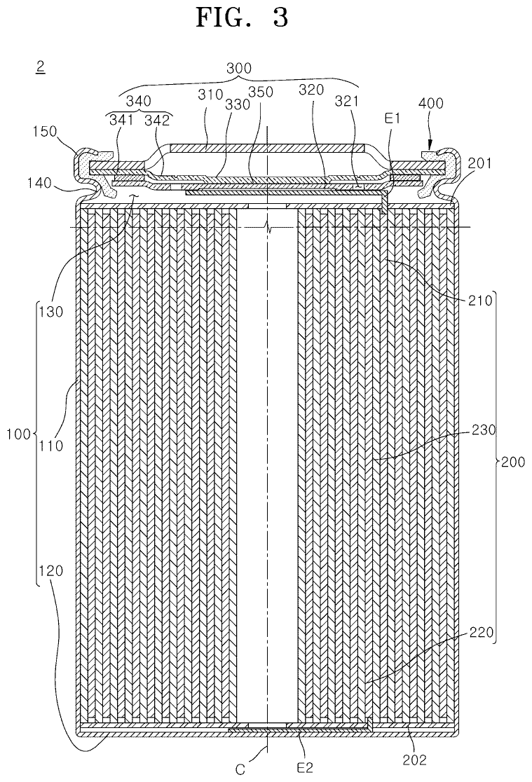

FIG. 2 is a schematic perspective view showing a structure of a secondary battery according to a first embodiment of the present disclosure, and FIG. 3 is a schematic cross-sectional view showing the structure of the secondary battery according to the first embodiment of the present disclosure.

Referring to FIGS. 2 and 3, a secondary battery 2 according to the present embodiment may include a case 100, an electrode assembly 200, and a cap assembly 300.

Hereinafter, an example of the secondary battery 2 that is a cylindrical lithium-ion secondary battery will be described. However, the present disclosure is not limited to such a battery, and the secondary battery 2 may be, for example, a lithium polymer battery or an angular battery.

The case 100 may form an exterior of the secondary battery 2. The case 100 may be provided to allow a current to flow through it. For example, the case 100 may include one or more materials of steel, stainless steel, aluminum, and an aluminum alloy. The case 100 may serve to protect the electrode assembly 200 from an external impact and serve a heat dissipation function of dissipating heat according to a charging and discharging operation of the electrode assembly 200.

The case 100 according to the present embodiment may include a cylindrical sidewall portion 110 in which a central axis C of the case 100 is formed in a central portion. The central axis C of the case 100, which will be described below, may be a central axis of the sidewall portion 110. Both end portions of the sidewall portion 110 that are perpendicular to the central axis C of the case 100 may be open.

The case 100 may further include a bottom portion 120 that closes a lower end portion of the sidewall portion 110. The bottom portion 120 according to the present embodiment may be formed to have substantially a disk shape and disposed to face the lower end portion of the sidewall portion 110. The bottom portion 120 may be disposed perpendicular to the central axis C of the case 100. A perimeter surface of the bottom portion 120 may be coupled to the lower end portion of the sidewall portion 110. The bottom portion 120 may be integrally molded with the sidewall portion 110 by a drawing process or the like. Alternatively, the bottom portion 120 may be manufactured separately from the sidewall portion 110 and then may be coupled to the sidewall portion 110 through welding or the like.

The case 100 may further include an opening portion 130 at an upper end portion of the sidewall portion 110. The opening portion 130 provides a passage through which the electrode assembly 200 (described below) is inserted into the case 100, in an upper end region of the case 100 and provides a space in which the cap assembly 300 (described below) may be installed. The opening portion 130 according to the present embodiment may be an empty space surrounded by a region of the upper end portion of the sidewall portion 110 located at the side that is opposite to the bottom portion 120.

The electrode assembly 200 may serve as a unit structure that performs a power charging and discharging operation in the secondary battery 2. The electrode assembly 200 may include a first electrode plate 210, a second electrode plate 220, and a separation membrane 230 disposed between the first electrode plate 210 and the second electrode plate 220.

The electrode assembly 200 may be disposed in the case 100. The electrode assembly 200 may be inserted into the case 100 through the opening portion 130 of the case 100.

The electrode assembly 200 may have a shape that is wound around a winding axis. More specifically, the electrode assembly 200 may have a shape in which the first electrode plate 210, the separation membrane 230, and the second electrode plate 220 are stacked and wound around the winding axis in a clockwise or counter-clockwise direction. Thus, the electrode assembly 200 may have substantially a jelly roll shape. But the cross-sectional shape of the electrode assembly 200 may be changed to any of various shapes other than a circular shape, such as an elliptical shape and a polygonal shape. In this embodiment, the winding axis may be a straight line passing through a central portion of the electrode assembly 200. The winding axis of the electrode assembly 200 may be coaxially disposed with the central axis C of the case 100.

The first electrode plate 210 may be a positive electrode of the electrode assembly 200. The first electrode plate 210 may be formed in the shape of a foil including a metal material such as aluminum or an aluminum alloy. The type, size, and shape of the first electrode plate 210 are not limited as long as a metal material has conductivity and does not cause a chemical change in the secondary battery.

A first active material layer may be applied on at least a portion of the first electrode plate 210. The first active material layer may be applied on each of both surfaces of the first electrode plate 210. Alternatively, the first active material layer may be applied on only one surface of the first electrode plate 210.

As the first electrode plate 210 serves as the positive electrode, the first active material layer may include a positive active material. The positive active material may be a reversible intercalation and deintercalation compound (lithiated intercalation compound) for lithium. More specifically, the positive active material may be one or more compound oxides of a metal selected from cobalt, manganese, nickel, iron, and a combination thereof and lithium may be used as the positive active material. As specific examples, the positive active material may include any one of a lithium-iron-phosphorus oxide (LiFePO₄, LFP), a lithium-manganese-iron-phosphorus oxide (LiMnFePO₄, LMFP), and a lithium-nickel-cobalt-manganese oxide (LiNiₓCo_{y}Mn_{z}O₂, NCM). In these formulas, 0<x<1, 0<y<1, 0<z<1, and x+y+z=1. The positive active material may include only any one of the lithium-iron-phosphorus oxide (LiFePO₄, LFP), the lithium-manganese-iron-phosphorus oxide (LiMnFePO₄, LMFP), and the lithium-nickel-cobalt-manganese oxide (LiNiₓCo_{y}Mn_{z}O₂, LNCM), or may include any two or all of the lithium-iron-phosphorus oxide (LiFePO₄, LFP), the lithium-manganese-iron-phosphorus oxide (LiMnFePO₄, LMFP), and the lithium-nickel-cobalt-manganese oxide (LiNiₓCo_{y}Mn_{z}O₂, LNCM).

The first active material layer may further include a positive conductive material. The positive conductive material provides conductivity to the first active material layer, and any material may be used as the positive conductive material as long as the material is electrically conductive and does not chemically change the first active material layer. Examples of the positive conductive material include a carbon-based material such as natural graphite, artificial graphite, carbon black, acetylene black, Ketjen black, carbon fibers, carbon nanofibers, and carbon nanotubes, a metal-based material in the form of a metal powder or metal fibers containing copper, nickel, aluminum, silver, and the like, a conductive polymer such as a polyphenylene derivative, or a mixture of such materials.

The first active material layer may further include a positive electrode binder. The positive electrode binder serves to attach particles constituting the positive active material and attach the positive active material to the first electrode plate 210.

A non-aqueous binder, an aqueous binder, a dry binder, or a combination thereof may be used as an example of the positive electrode binder.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, ethylene propylene diene copolymer, polyvinylpyridine, chlorosulfonated polyethylene, latex, a polyester resin, a (meth)acrylic resin, a phenol resin, an epoxy resin, polyvinyl alcohol, and combinations thereof.

When the aqueous binder is used as the positive electrode binder, the first active material layer may further include a cellulose compound that provides viscosity. One or more of carboxymethyl cellulose, hydroxypropyl methyl cellulose, methyl cellulose, and alkaline metal salts thereof may be mixed and used as the cellulose compound. Na, K, or Li may be used as an alkaline metal.

The dry binder is a fibrous polymer material, and may be, for example, polytetrafluoroethylene, polyvinylidene fluoride, a polyvinylidene fluoride-hexafluoropropylene copolymer, polyethylene oxide, or a combination thereof.

The first electrode plate 210 may be electrically connected to the cap assembly 300, which will be described below. As the first electrode plate 210 is the positive electrode of the electrode assembly 200, the cap assembly 300 may be a positive terminal of the secondary battery 2. As an example, the first electrode plate 210 may be electrically connected to the cap assembly 300 through a first electrode tab E1. The first electrode tab E1 according to the present embodiment may include a conductive metal material such as copper, a copper alloy, nickel, or a nickel alloy. The first electrode tab E1 may be disposed on the electrode assembly 200, and the end portions of the first electrode tab E1 may be connected to the first electrode plate 210 and the cap assembly 300. One end portion of the first electrode tab E1 may be directly connected to the first electrode plate 210 or indirectly connected to the first electrode plate 210 through a separate current collection plate (not shown) connected to the first electrode plate 210. However, the first electrode plate 210 is not limited to such a configuration and may be directly connected to the cap assembly 300 without the first electrode tab E1.

The second electrode plate 220 may be a negative electrode of the electrode assembly 200. The second electrode plate 220 may be formed in the shape of a foil including a metal material such as copper, a copper alloy, nickel, or a nickel alloy. The second electrode plate 220 may be spaced a predetermined distance from the first electrode plate 210 and face the first electrode plate 210.

The type, size, and shape of the second electrode plate 220 are not limited as long as the metal material has conductivity and does not cause a chemical change in the secondary battery.

A second active material layer may be applied on at least a portion of the second electrode plate 220. The second active material layer may be applied on each of both surfaces of the second electrode plate 220. Alternatively, the second active material layer may be applied on only one surface of the second electrode plate 220.

As the second electrode plate 220 is the negative electrode, the second active material layer may include a negative active material.

The negative active material may include a material into which lithium ions may be reversibly intercalated and/or from which lithium ions may be reversibly deintercalated, a lithium metal, a lithium metal alloy, a material which may be doped in and undoped from lithium, or a transition metal oxide.

The material, into which lithium ions may be reversibly intercalated and/or from which lithium ions may be reversibly deintercalated, may include a carbon-based negative active material, such as, crystalline carbon, amorphous carbon, or a combination thereof. Examples of the crystalline carbon are graphite such as natural graphite or artificial graphite in amorphous, flake, spherical, or fibrous form, and an example of the amorphous carbon may be soft or hard carbon, mesophase pitch carbide, fired coke, or the like.

An alloy of lithium and a metal selected from Na, K, Rb, Cs, Fr, Be, Mg, Ca, Sr, Si, Sb, Pb, In, Zn, Ba, Ra, Ge, Al, and Sn may be used as the lithium metal alloy.

A Si-based negative active material or a Sn-based negative active material may be used as the material which may be doped in and undoped from lithium. The Si-based negative active material may be silicon, a silicon-carbon composite, SiOₓ (x=1 or 2), a Si-Q alloy or a combination thereof. In the Si-Q formula, Q is selected from alkaline metals, alkaline earth metals, Group 13 elements, Group 14 elements (excluding Si), Group 15 elements, Group 16 elements, transition metals, rare earth elements, and combinations thereof. The Sn-based negative active material may be Sn, SnO₂, a Sn-based alloy, or a combination thereof.

The silicon-carbon composite may be a composite of silicon and amorphous carbon. According to one embodiment, the silicon-carbon composite may have a form including silicon particles and amorphous carbon applied on surfaces of the silicon particles. For example, the silicon-carbon composite may include secondary particles (core) in which silicon primary particles are assembled and amorphous carbon coated layers (shell) located on surfaces of the secondary particles. The amorphous carbon may also be located between the silicon primary particles so that, for example, the silicon primary particles may be coated with the amorphous carbon. The secondary particles may be dispersed in an amorphous carbon matrix.

The silicon-carbon composite may also further include crystalline carbon. For example, the silicon-carbon composite may include a core including the crystalline carbon and the silicon particles and the amorphous carbon coated layer located on a surface of the core.

The Si-based negative active material or the Sn-based negative active material may be mixed with the carbon-based negative active material and used.

The second active material layer may further include a negative conductive material and a negative electrode binder.

The negative conductive material is used for providing conductivity to the second active material layer, and any material may be used as the negative conductive material as long as the material is electrically conductive and does not cause a chemical change in the second active material layer. An example of the negative conductive material may be a carbon-based material such as natural graphite, artificial graphite, carbon black, acetylene black, Ketjenblack, carbon fibers, carbon nanofibers, and carbon nanotubes, a metal-based material in the form of a metal powder or metal fibers containing copper, nickel, aluminum, silver, and the like, a conductive polymer such as a polyphenylene derivative, or a mixture thereof.

The negative electrode binder serves to attach particles constituting the negative active material and attach the negative active material to the second electrode plate 220.

A non-aqueous binder, an aqueous binder, a dry binder, or a combination thereof may be used as the negative electrode binder.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof. The aqueous binder may be selected from styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene diene propylene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the first active material layer may further include a cellulose compound that provides viscosity. One or more of carboxymethyl cellulose, hydroxypropyl methyl cellulose, methyl cellulose, and alkaline metal salts thereof may be mixed and used as the cellulose compound. Na, K, or Li may be used as an alkaline metal.

The dry binder is a fibrous polymer material, and may be, for example, polytetrafluoroethylene, polyvinylidene fluoride, a polyvinylidene fluoride-hexafluoropropylene copolymer, polyethylene oxide, or a combination thereof.

The second electrode plate 220 may be electrically connected to the case 100. As an example, the second electrode plate 220 may be electrically connected to the case 100 through a second electrode tab E2. As the second electrode plate 220 is the negative electrode of the electrode assembly 200, the case 100 may be a negative terminal of the secondary battery 2. The second electrode tab E2 according to the present embodiment may include a conductive metal material such as copper, a copper alloy, nickel, or a nickel alloy. The second electrode tab E2 may be disposed under the electrode assembly 200, an end portions of the second electrode tab E2 may be connected to the second electrode plate 220 and the bottom portion 120 of the case 100. One end portion of the second electrode tab E2 may be directly connected to the second electrode plate 220 or indirectly connected to the second electrode plate 220 through a separate current collection plate (not shown) connected to the second electrode plate 220. However, the second electrode plate 220 is not limited to such a configuration and may be directly connected to the case 100 without the second electrode tab E2.

The separation membrane 230 may be disposed between the first electrode plate 210 and the second electrode plate 220. The separation membrane 230 may serve to allow lithium ions to move between the first electrode plate 210 and the second electrode plate 220 and prevent a shout circuit between the first electrode plate 210 and the second electrode plate 220.

Polyethylene, polypropylene, polyvinylidene fluoride, or a multilayer membrane with two or more layers thereof may be used as the separation membrane 230, and a mixed multilayer membrane such as a two-layer separator with polyethylene/polypropylene, a three-layer separator with polyethylene/polypropylene/polyethylene, and a three-layer separator with polypropylene/polyethylene/polypropylene may be used as the separation membrane 230.

The separation membrane 230 may include a porous substrate and a coated layer that is located on one surface or both surfaces of the porous substrate and includes an organic material, an inorganic material, or a combination thereof.

The porous substrate may be selected from polyolefins such as polyethylene and polypropylene, polyesters such as polyethylene terephthalate and polybutylene terephthalate, polyacetal, polyamide, polyimide, polycarbonate, polyetherketone, polyaryl etherketone, polyetherimide, polyamideimide, polybenzimidazole, polyethersulfone, polyphenylene oxide, cyclic olefin copolymers, polyphenylene sulfide, polyethylene naphthalate, glass fiber, Teflon®, and polytetrafluoroethylene, or a polymer membrane formed of two or more of these copolymers or mixtures.

The organic material may include a polyvinylidene fluoride-based polymer or (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH₂), boehmite and a composition thereof. But the present disclosure is not limited to these examples.

The organic material and the inorganic material may be mixed and be formed as one coated layer or may be formed as a first coated layer including the organic material and a second coated layer including the inorganic material, with the first and second coating layers being stacked.

The separation membrane 230 may be provided as a pair of separation membranes 230. The pair of separation membranes 230 may be disposed to face surfaces of the first electrode plate 210 or the second electrode plate 220. The pair of separation membranes 230 may be wound around the winding axis with the first electrode plate 210 and the second electrode plate 220.

A first insulation plate 201 and a second insulation plate 202 may be disposed on both sides of the electrode assembly 200. Each of the first insulation plate 201 and the second insulation plate 202 may include an insulation material such as rubber, polyethylene (PE), polypropylene (PP), or polyethylene terephthalate (PET).

The first insulation plate 201 according to the present embodiment may be in substantially a disk shape. The first insulation plate 201 may be disposed between an upper surface of the electrode assembly 200 and the cap assembly 300. Accordingly, the first insulation plate 201 may prevent the upper surface of the electrode assembly 200 from being in direct contact with the cap assembly 300 and insulate the electrode assembly 200 from the cap assembly 300. A hole (not shown) through which the first electrode tab E1 may pass may be formed in the first insulation plate 201.

The second insulation plate 202 according to the present embodiment may be formed in substantially a disk shape. The second insulation plate 202 may be disposed between a lower surface of the electrode assembly 200 and the bottom portion 120 of the case 100. Accordingly, the second insulation plate 202 may prevent the lower surface of the electrode assembly 200 from being in direct contact with the bottom portion 120 of the case 100 and insulate the electrode assembly 200 from the bottom portion 120 of the case 100. A hole (not shown) through which the second electrode tab E2 may pass may be formed in the second insulation plate 202.

The cap assembly 300 may be coupled to the case 100 and may seal the opening portion 130 of the case 100.

As an example, the cap assembly 300 may be disposed in the upper end portion of the sidewall portion 110 that is adjacent to the opening portion 130. A beading part 140 that is recessed toward the central axis C of the case 100 may be formed in the sidewall portion 110. The beading part 140 may be disposed under the cap assembly 300 and may restrict the cap assembly 300 from being moved a predetermined distance or more into the case 100. A crimping part 150, in which the upper end portion of the sidewall portion 110 is bent toward the central axis C of the case 100, may be formed above the beading part 140. The crimping part 150 may be formed at an upper side of the cap assembly 300 and may prevent the cap assembly 300 from being separated to the outside of the case 100.

A gasket 400 may be disposed between the case 100 and the cap assembly 300. The gasket 400 fixes a location of the cap assembly 300 at the opening portion 130 using an elastic restoring force of the gasket 400, electrically insulates the case 100 from the cap assembly 300, and blocks moisture or electrolyte from being introduced or discharged through a gap between the case 100 and the cap assembly 300.

The gasket 400 according to the present embodiment may include an insulation material such as rubber, PE, PP, or PET. The gasket 400 may be formed in substantially a ring shape and disposed inside the beading part 140 and/or the crimping part 150. An outer surface of the gasket 400 may be in contact with an inner surface of the beading part 140 and/or the crimping part 150, and an inner surface of the gasket 400 may be in close contact with an outer surface of the cap assembly 300. The gasket 400 may be disposed inside the beading part 140 and/or the crimping part 150.

The cap assembly 300 may be electrically connected to the first electrode plate 210 through the first electrode tab E1. As the first electrode plate 210 is the positive electrode of the electrode assembly 200, the cap assembly 300 may be a positive terminal of the secondary battery.

The cap assembly 300 may block electrical connection between the secondary battery 2 and an external device when an internal pressure of the case 100 increases due to an overcurrent or the like. The cap assembly 300 may be broken to allow an inner space of the case 100 to be in fluid communication with outside of the case 100 when the internal pressure of the case 100 increases to a predetermined magnitude or more. Accordingly, the cap assembly 300 may lower a risk of explosion of the secondary battery 2 when an overcurrent is generated.

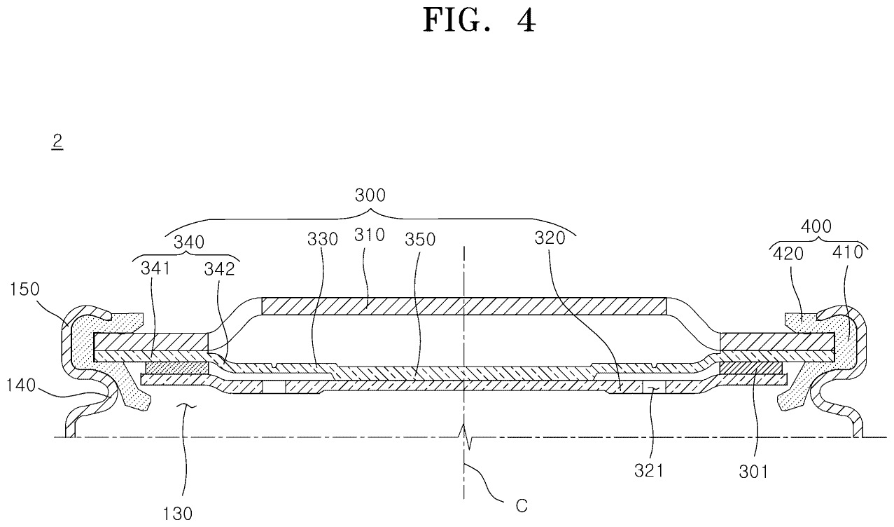

FIG. 4 is a schematic enlarged view showing a structure of the cap assembly according to the first embodiment of the present disclosure.

Referring to FIGS. 1 to 4, the cap assembly 300 according to the present embodiment may include an upper cap 310, a lower cap 320, a bent plate 330, an extension portion 340, and a contact portion 350.

The upper cap 310 may form an upper exterior of the cap assembly 300 and may be disposed in the opening portion 130. The upper cap 310 may be electrically connected to the first electrode plate 210 through the lower cap 320 and the bent plate 330, which will be described below.

The upper cap 310 according to the present embodiment may have a disk shape with a central portion that convexly protrudes upward. A central axis of the upper cap 310 may be coaxial with the central axis C of the case 100. The central portion of the upper cap 310 may protrude outward from the case 100. An edge portion of the upper cap 310 may be disposed in the case 100. A perimeter surface of the edge portion of the upper cap 310 may be spaced a predetermined distance from the inner surface of the gasket 400. The upper cap 310 may be formed of a material through which a current may flow, such as nickel, aluminum, or copper.

An upper cap hole 311 for discharging gas or the like generated in the case 100 to the outside of the case 100 may be formed in the upper cap 310. The upper cap hole 311 according to the present embodiment may have a shape passing through a perimeter surface of the central portion of the upper cap 310. The upper cap hole 311 may be provided as a plurality of upper cap holes 311. The plurality of upper cap holes 311 may be disposed at predetermined intervals along the perimeter surface of the central portion of the upper cap 310.

The lower cap 320 may be disposed to face the upper cap 310 and be electrically connected to the electrode assembly 200.

The lower cap 320 according to the present embodiment may be a disk shape and disposed in the case 100. The lower cap 320 may be disposed under the upper cap 310. That is, the lower cap 320 may be disposed between the upper cap 310 and the electrode assembly 200. A central axis of the lower cap 320 may be coaxial with the central axis C of the case 100. An upper surface of the lower cap 320 may be spaced apart from a lower surface of the upper cap 310.

An area of the lower cap 320 may be smaller than a cross-sectional area (perpendicular to the central axis C of the case 100) the cross-sectional area of the electrode assembly 200. However, the cross-sectional area area of the lower cap 320 is not limited to such a configuration and may be the same as the cross-sectional area of the electrode assembly 200 or greater than the cross-sectional area of the electrode assembly 200.

The lower cap 320 may be formed of a material through which a current may flow, such as nickel, aluminum, or copper. The lower cap 320 may be electrically connected to the electrode assembly 200. As an example, the end portion of the first electrode tab E1 extending from the first electrode plate 210 may be connected to a lower surface of the lower cap 320 through any of various coupling methods such as welding. The lower cap 320 may be electrically connected to the upper cap 310 through the bent plate 330 which will be described below.

A lower cap hole 321 vertically passing through the lower cap 320 may be formed in the lower cap 320. The lower cap hole 321 may provide a passage through which gas or the like generated in the case 100 flows through the lower cap 320 when an overcurrent is generated in the battery. The lower cap hole 321 may be provided as a plurality of lower cap holes 321. The plurality of lower cap holes 321 may be disposed along a circumference around the central axis of the lower cap 320.

The bent plate 330 may be disposed between the upper cap 310 and the lower cap 320. When the secondary battery 2 operates normally, the bent plate 330 may provide a passage to allow a current to flow between the upper cap 310 and the lower cap 320. When an overcurrent is generated, the bent plate 330 is deformed due to a pressure of gas generated in the case 100 to block electrical connection between the upper cap 310 and the lower cap 320. When an inner pressure of the case 100 increases to a preset magnitude or more, the bent plate 330 may be broken to open the gas discharge passage between the upper cap hole 311 and the lower cap hole 321.

The bent plate 330 according to the present embodiment may be formed in substantially a disk shape. Upper and lower surfaces of the bent plate 330 may be disposed to face the upper cap 310 and the lower cap 320, respectively. The lower surface of the bent plate 330 may be disposed to face the lower cap hole 321. A central axis of the bent plate 330 may be coaxial with the central axis C of the case 100. The bent plate 330 may be formed of a material through which a current may flow, such as nickel, aluminum, or copper.

An insulator 301 may be disposed between the bent plate 330 and the lower cap 320. The insulator 301 may prevent direct contact between the bent plate 330 and the lower cap 320 and induces the bent plate 330 and the lower cap 320 to be electrically connected through only the contact portion 350, which will be described below.

The insulator 301 according to the present embodiment may be formed in a hollow ring shape. A central axis of the insulator 301 may be coaxial with the central axis C of the case 100 and the central axis of the bent plate 330. An upper surface of the insulator 301 may be in contact with the lower surface of the bent plate 330, and a lower surface of the insulator 301 may be in contact with the upper surface of the lower cap 320. The insulator 301 may be formed of an insulation material such as PE, PP, or PET.

The extension portion 340 may extend from the bent plate 330 and may be connected to the upper cap 310. The extension portion 340 may serve as a part which supports the bent plate 330 against the upper cap 310 and provides electrical connection between the upper cap 310 and the bent plate 330. The extension portion 340 may be formed of the same material as the bent plate 330.

The extension portion 340 according to the present embodiment may include a support part 341 and a hinge part 342. The support part 341 may form an exterior of one side of the extension portion 340 and may be connected to the upper cap 310.

The support part 341 according to the present embodiment may be disposed between the lower surface of the upper cap 310 and the upper surface of the insulator 301.

The support part 341 according to another present embodiment may be disposed to surround an end portion of the upper cap 310, that is, an edge region of the upper cap 310 facing the gasket 400. As an example, a cross-sectional shape of the support part 341 may have substantially a “U” shape. One end portion of the support part 341 may be in contact with an upper surface of the upper cap 310, and the other end portion of the support part 341 may be bent downward to be in contact with the lower surface of the upper cap 310. The support part 341 may be coupled to the upper cap 310 through any of various methods such as laser welding, ultrasonic welding, and resistance welding.

The hinge part 342 may form an exterior of the other side of the extension portion 340 and may be disposed between the support part 341 and the bent plate 330. The hinge part 342 may connect the support part 341 and the bent plate 330 and induces deformation of the bent plate 330 when an internal pressure of the case 100 increases.

The hinge part 342 according to the present embodiment may have a substantially circular ring shape and may be disposed between the support part 341 and the bent plate 330. An inner circumferential surface of the hinge part 342 may be connected to the bent plate 330, and an outer circumferential surface of the hinge part 342 may be connected to the other end portion of the support part 341. The hinge part 342 may be formed to be stepped downward from the outer circumferential surface toward the inner circumferential surface.

As an example, a central portion of the hinge part 342 may have a cross section bent in an “L” shape. The angle of the central portion of the hinge part 342 may be changed to any of various angles other than the angle illustrated in FIG. 4.

When an overcurrent is generated, the bent plate 330 may be deformed with respect to the hinge part 342. As an example, when an internal pressure of the case 100 increases due to an overcurrent, gas passing through the lower cap hole 321 may press the bent plate 330 upward, and the bent plate 330 may be deformed such that a central portion of the bent plate 330 convexly protrudes upward due to a change in the bending angle of the hinge part 342.

The contact portion 350 may protrude from the bent plate 330 toward the lower cap 320 and may be in contact with the lower cap 320. The contact portion 350 may electrically connect the bent plate 330 and the lower cap 320. Accordingly, a current generated from the first electrode plate 210 may be transmitted to the upper cap 310 sequentially through the first electrode tab E1, the lower cap 320, the contact portion 350, the bent plate 330, and the extension portion 340.

The contact portion 350 according to the present embodiment may protrude downward from the lower surface of the bent plate 330. A lower surface of the contact portion 350 may be in contact with the upper surface of the lower cap 320. A central axis of the contact portion 350 may be coaxial with the central axis C of the case 100 and the central axis of the bent plate 330. The diameter of the contact portion 350 may be smaller than an inner diameter of the insulator 301.

When the bent plate 330 is deformed due to an increase in internal pressure of the case 100, the contact portion 350 may be separated from the lower cap 320. Accordingly, when an overcurrent is generated, electrical connection between the lower cap 320 and the bent plate 330 may be blocked. A thickness of a portion of the bent plate 330 according to the present embodiment may increase toward the central axis C of the case 100. In this case, a thickness of the bent plate 330 may be a vertical length of the bent plate 330 parallel to the central axis C of the case 100.

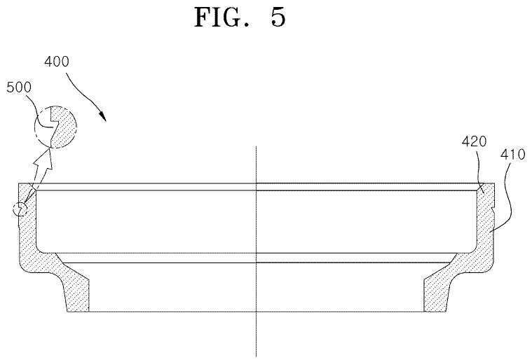

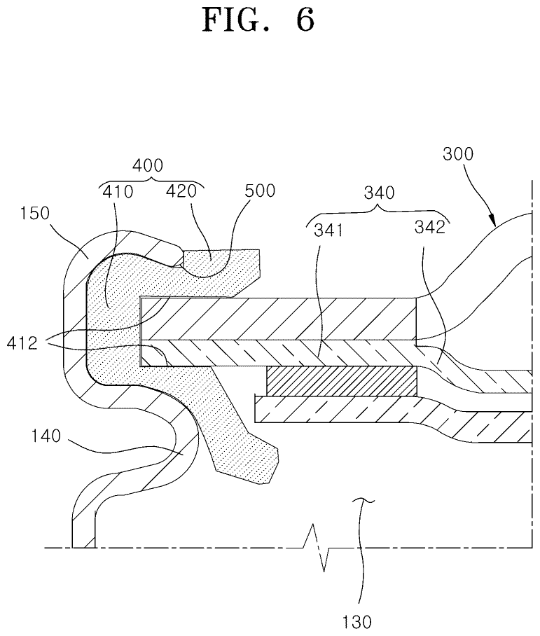

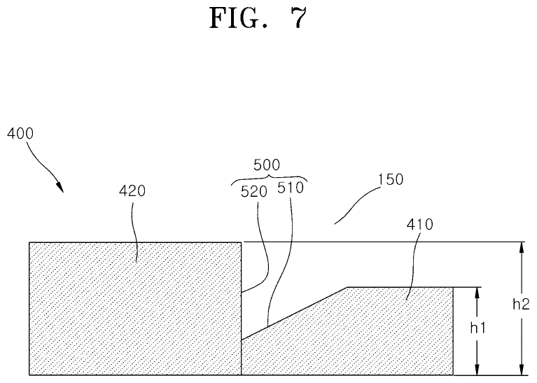

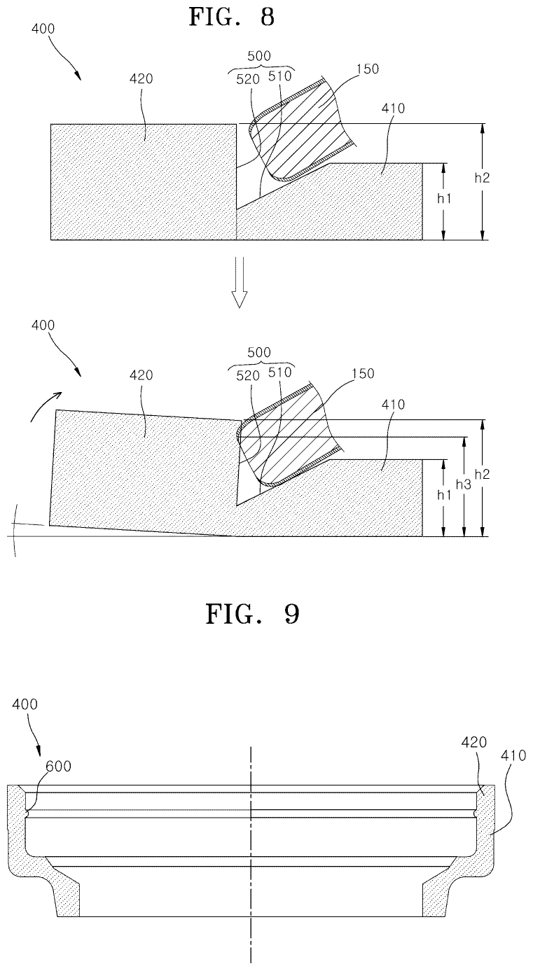

FIG. 5 is a cross-sectional view showing the gasket 400 according to the first embodiment of the present disclosure, and FIG. 6 is an enlarged view illustrating the cap assembly 300, to which the gasket 400 is applied, according to the first embodiment of the present disclosure. FIG. 7 is an enlarged view showing an accommodation groove 500 according to the first embodiment of the present disclosure, and FIG. 8 is a view for describing an operation of the gasket 400 due to crimping according to the first embodiment of the present disclosure.

Referring to FIGS. 5 to 8, the gasket 400 according to the present embodiment may include a first gasket 410 and a second gasket 420.

The first gasket 410 may be disposed between the cap assembly 300 and the crimping part 150, and the second gasket 420 may be formed to extend from the first gasket 410 and protrude outward from the crimping part 150. That is, the first gasket 410 and the second gasket 420 are integrally formed, with the first gasket 410 is disposed in the crimped crimping part 150, and the second gasket 420 protrudes outward from the crimped crimping part 150 and extending toward a center of the cap assembly 300.

Referring to FIG. 6, the first gasket 410 may include two horizontal surfaces 412 surrounding an end portion of the cap assembly 300. More specifically, a cross section of the first gasket 410 may be formed in a “C” shape, and the first gasket 410 may be formed to surround an end portion of the extension portion 340. Although not illustrated in the drawing, uneven patterns for increasing a sealing force may be formed on the horizontal surfaces 412 of the first gasket 410 facing each other.

The second gasket 420 may be spaced apart from the cap assembly 300 and is in contact with an end portion of the crimping part 150 to cover the end portion of the crimping part 150 when the crimping part 150 is crimped. Accordingly, the second gasket 420 prevents the end portion of the crimping part 150 from contact with oxygen and being thereafter being corroded. In other words, a portion on which Ni is not plated may be formed on the end portion of the crimping part 150, and when the end portion is exposed to outside of the battery, the end portion may come into contact with oxygen and may be corroded. However, the second gasket 420 may prevent such corrosion.

Referring to FIG. 7, a height h2 of the second gasket 420 may be greater than a height h1 of the first gasket 410. Since the second gasket 420 is thicker than the first gasket 410, a step may be formed between the first gasket 410 and the second gasket 420. When the crimping part 150 is crimped, an inner surface of the second gasket 420 forming the step may be in contact with the end portion of the crimping part 150 to cover the end portion of the crimping part 150.

In addition, since a boundary portion between the first gasket 410 and the second gasket 420 is pressed when the crimping part 150 is crimped, a portion of the second gasket 420 is bent and spaced apart from an upper surface of the cap assembly 300. Thus, the second gasket 420 may cover the end portion of the crimping part 150 along a wider area.

The first gasket 410 may include an accommodation groove 500 in which the end portion of the crimping part 150 is accommodated. The accommodation groove 500 may be formed to extend from an upper surface of the first gasket 410 toward the second gasket 420. The accommodation groove 500 may be a part in which the end portion of the crimping part 150 is accommodated when the crimping part 150 is crimped. More specifically, the accommodation groove 500 may include an inclined accommodation surface 510 that is inclined downward from the upper surface of the first gasket 410 toward the second gasket 420 and a vertical accommodation surface 520 vertically extending from an end portion of the inclined accommodation surface 510. Accordingly, when the crimping part 150 is crimped, the end portion of the crimping part 150 may be inclined downward at a predetermined angle and accommodated in the accommodation groove 500, may be in contact with the vertical accommodation surface 520, and may be covered by the vertical accommodation surface 520 as illustrated in FIG. 8. In this case, the height h2 of the second gasket 420 may be greater than a height h3 of the end portion of the crimping part 150 accommodated in the accommodation groove 500.

Hereinafter, a secondary battery 2 according to a second embodiment of the present disclosure will be described.

The secondary battery 2 according to the second embodiment is such that only the gasket 400 of the secondary battery 2 is different from that of the gasket 400 of the secondary battery according to the first embodiment of the present disclosure. Accordingly, only the gasket 400 which is different from the gasket 400 of the secondary battery 2 according to the first embodiment of the present disclosure will be described. That is, as the description of the rest of the secondary battery according to this embodiment is the same as secondary battery 2 according to the first embodiment, a description of the rest of the secondary battery will be omitted.

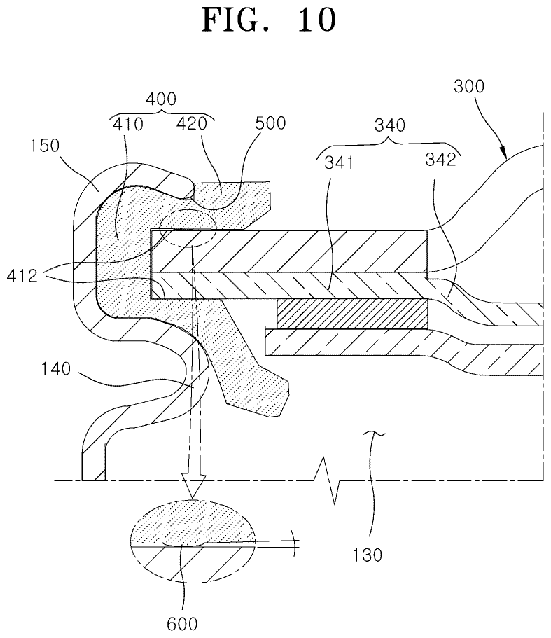

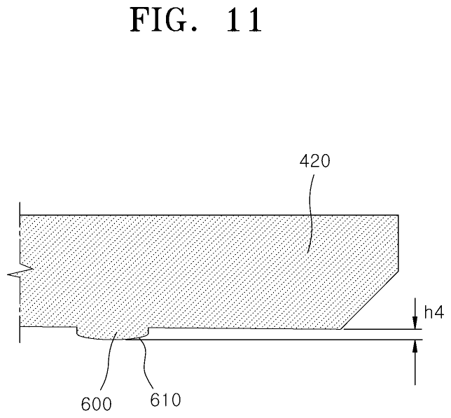

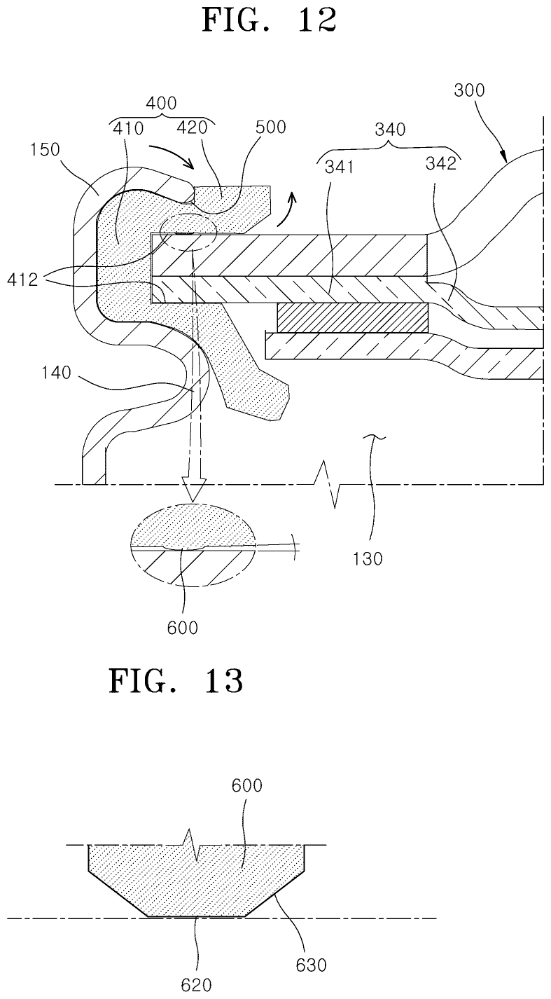

FIG. 9 is a cross-sectional view showing the gasket 400 according to a second embodiment of the present disclosure, and FIG. 10 is an enlarged view illustrating a cap assembly 300, to which the gasket 400 is applied, according to the second embodiment of the present disclosure. FIG. 11 is an enlarged view showing a close-contact protrusion 600 according to the second embodiment of the present disclosure, and FIG. 12 is a view for describing an operation of the gasket 400 due to crimping according to the second embodiment of the present disclosure.

Referring to FIGS. 9 to 12, a first gasket 410 according to the second embodiment of the present disclosure may be disposed between the cap assembly 300 and a crimping part 150. A second gasket 420 may extend from the first gasket 410 and protrude outward from the crimping part 150. The first gasket 410 and the second gasket 420 are integrally formed, the first gasket 410 is disposed in the crimped crimping part 150, and the second gasket 420 protrudes outward from the crimped crimping part 150 and extends toward a center of the cap assembly 300.

Referring to FIG. 10, the first gasket 410 may include two horizontal surfaces 412 surrounding an end portion of the cap assembly 300. More specifically, a cross section of the first gasket 410 may be formed in a “C” shape, and the first gasket 410 may be formed to surround an end portion of an extension portion 340.

The second gasket 420 may be spaced apart from the cap assembly 300 and may be in contact with an end portion of the crimping part 150 to cover the end portion of the crimping part 150 when the crimping part 150 is crimped to prevent corrosion due to external exposure.

Since a boundary portion between the first gasket 410 and the second gasket 420 is pressed when the crimping part 150 is crimped, a portion of the second gasket 420 may be bent and spaced apart from an upper surface of the cap assembly 300. Thus, the second gasket 420 may cover the end portion of the crimping part 150 along a wider area.

The second gasket 420 may include the close-contact protrusion 600 that is separated from the cap assembly 300 when the crimping part 150 is crimped. The close-contact protrusion 600 may be formed on a lower surface of the second gasket 420 that is in contact with the upper surface of the cap assembly 300 when the crimping part 150 is crimped.

A location of the close-contact protrusion 600 may be disposed at a location corresponding to the end portion of the crimped crimping part 150 or disposed toward the second gasket 420 with respect to the end portion of the crimped crimping part 150. The close-contact protrusion 600 may increase a sealing force through pressing of the crimping part 150 and allow the second gasket 420 to be bent and spaced apart from the cap assembly 300 when the crimping part 150 is crimped.

Referring to FIGS. 11 and 12, the close-contact protrusion 600 may include a curved surface 610 in contact with the cap assembly 300. A lower surface of the close-contact protrusion 600 in contact with the upper surface of the cap assembly 300 may be rounded as the curved surface 610 and may be in closer contact with the upper surface of the cap assembly 300 due to a pressing force of the crimping part 150 to thereby increase a sealing force of the gasket 400. In addition, due to the location of the close-contact protrusion 600, the close-contact protrusion 600 may be twisted outward from the cap assembly 300 when the crimping part 150 is crimped. However, the sealing force may be maintained by the curved surface 610.

A height h4 of the close-contact protrusion 600 may range from 0.1 mm to 0.2 mm. When the height h4 of the close-contact protrusion 600 is less than 0.1 mm, a distance by which the second gasket 420 is spaced apart from the cap assembly 300 is small, and the end portion of the crimping part 150 is not covered when the crimping part 150 is crimped. When the height h4 is greater than 0.2 mm, the sealing force of the close-contact protrusion 600 may decrease when the crimping part 150 is crimped.

As described above, due to the location and the height of the close-contact protrusion 600, the close-contact protrusion 600 may serve as a lever to effectively induce a lifting operation of a portion of the second gasket 420 to easily cover the end portion of the crimping part 150 when the crimping part 150 is crimped.

FIG. 13 is a view showing a modified example of the close-contact protrusion 600 according to the second embodiment of the present disclosure.

A close-contact protrusion 600 according to the present embodiment may include a straight surface 620 in contact with a cap assembly 300 and an inclined surface 630 inclined upward from the straight surface 620. A lower end portion of the close-contact protrusion 600 in contact with an upper surface of the cap assembly 300 is formed in a tapered shape. Accordingly, the lower end portion of the close-contact protrusion 600 may be in closer contact with the upper surface of the cap assembly 300 to increase a sealing force due to a pressing force of a crimping part 150. In addition, the close-contact protrusion 600 may be twisted outward from the cap assembly 300 due to a location of the close-contact protrusion 600 when the crimping part 150 is crimped. However, since the inclined surface 630 is in contact with the upper surface of the cap assembly 300, the sealing force may be maintained.

Although not illustrated in the drawings, the second embodiment of the present disclosure may further include the accommodation groove 500 as in the first embodiment of the present disclosure. That is, an accommodation groove 500 that accommodates an end portion of the crimping part 150 may be formed in a first gasket 410 to block the end portion of the crimping part 150 from being exposed, and a second gasket 420 may be spaced apart from the upper surface of the cap assembly 300 due to the close-contact protrusion 600 and may cover the end portion of the crimping part 150.

Hereinafter, a secondary battery 2 according to a third embodiment of the present disclosure will be described.

The secondary battery 2 according to the third embodiment is such that only the gasket 400 of the secondary battery 2 is different from that of the gasket 400 of the secondary battery 2 according to the first embodiment of the present disclosure. Accordingly, only the gasket 400 which is different from the gasket 400 of the secondary battery 2 according to the first embodiment of the present disclosure will be described. That is, as the description of the rest of the secondary battery according to this embodiment is the same as secondary battery 2 according to the first embodiment, a description of the rest of the secondary battery will be omitted.

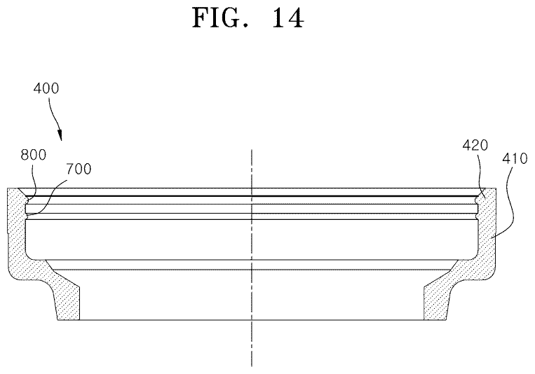

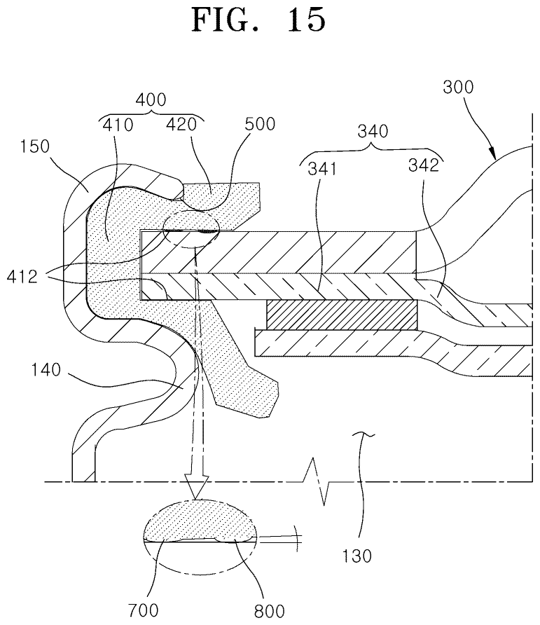

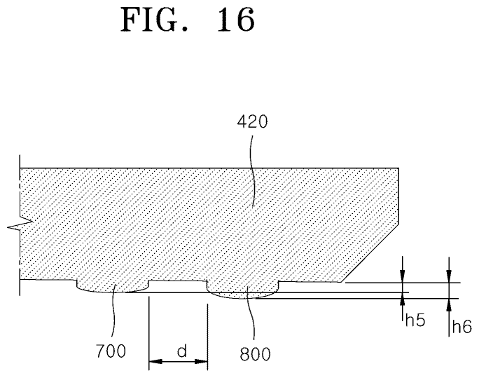

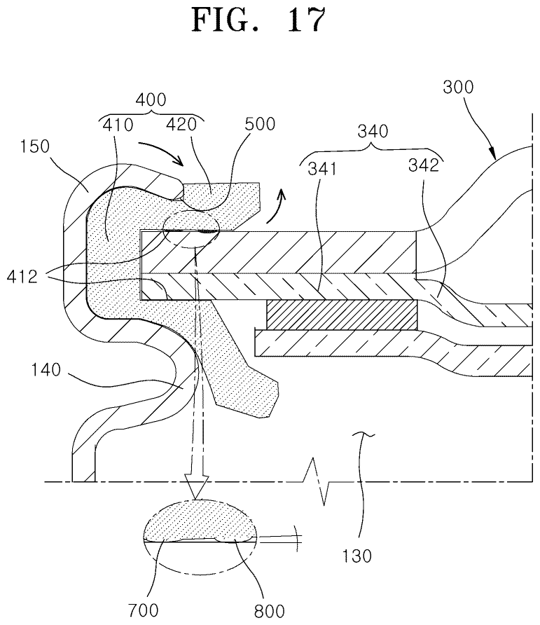

FIG. 14 is a cross-sectional view showing the gasket 400 according to the third embodiment of the present disclosure, and FIG. 15 is an enlarged view illustrating a cap assembly 300, to which the gasket 400 is applied, according to the third embodiment of the present disclosure. FIG. 16 is an enlarged view showing a close-contact protrusion 600 according to the third embodiment of the present disclosure, and FIG. 17 is a view for describing an operation of the gasket 400 due to crimping according to the third embodiment of the present disclosure.

Referring to FIGS. 14 to 17, a first gasket 410 according to the third embodiment of the present disclosure may be disposed between the cap assembly 300 and a crimping part 150. A second gasket 420 may be formed to extend from the first gasket 410 and protrude outward from the crimping part 150. The first gasket 410 and the second gasket 420 are integrally formed. The first gasket 410 may be disposed in the crimped crimping part 150, and the second gasket 420 may protrude outward from the crimped crimping part 150 and extends toward a center of the cap assembly 300.

Referring to FIG. 15, the first gasket 410 may include two horizontal surfaces 412 surrounding an end portion of the cap assembly 300. More specifically, a cross section of the first gasket 410 may be formed in a “C” shape, and the first gasket 410 may be formed to surround an end portion of an extension portion.

The second gasket 420 may be a part that is spaced apart from the cap assembly 300 and may be in contact with an end portion of the crimping part 150 to cover the end portion of the crimping part 150 when the crimping part 150 is crimped to prevent corrosion due to external exposure.

Since a boundary portion between the first gasket 410 and the second gasket 420 is pressed when the crimping part 150 is crimped, a portion of the second gasket 420 may be bent and spaced apart from an upper surface of the cap assembly 300. Thus, the second gasket 420 may cover the end portion of the crimping part 150 along a wider area.

The second gasket 420 may include a first close-contact protrusion 700 in contact with the cap assembly 300 and a second close-contact protrusion 800 disposed to be spaced apart from the first close-contact protrusion 700 and in contact with the cap assembly 300. The first close-contact protrusion 700 and the second close-contact protrusion 800 may be formed on a lower surface of the second gasket 420 that is in contact with the upper surface of the cap assembly 300 when the crimping part 150 is crimped.

A location of the first close-contact protrusion 700 may be correspond to the end portion of the crimped crimping part 150 or toward the second gasket 420 with respect to the end portion of the crimped crimping part 150. A location of the second close-contact protrusion 800 is spaced apart from the first close-contact protrusion 700 toward a center of the cap assembly 300. Accordingly, when the crimping part 150 is crimped, the first close-contact protrusion 700 is pressed to increase a sealing force by pressure from the crimping part 150. And, since a space is formed between the first close-contact protrusion 700 and the second close-contact protrusion 800, the second gasket 420 may be bent further and spaced apart from the cap assembly 300 and may surround the end portion of the crimping part 150. Accordingly, the second gasket 420 may cover the end portion of the crimping part 150 to prevent corrosion.

Referring to FIG. 16, each of the first close-contact protrusion 700 and the second close-contact protrusion 800 may be formed in a hemisphere shape. Each of the first close-contact protrusion 700 and the second close-contact protrusion 800 may include a curved surface 610 as in the close-contact part of the second embodiment. A lower surface of the first close-contact protrusion 700 in contact with the upper surface of the cap assembly 300 may be formed to be rounded as the curved surface 610 and may be in closer contact with the upper surface of the cap assembly 300 due to a pressing force of the crimping part 150 to thereby increase the sealing force.

Due to the location of the first close-contact protrusion 700, the close-contact protrusion 600 may be twisted outward from the cap assembly 300 when the crimping part 150 is crimped. However, the sealing force may be maintained by the curved surface 610.

A height h5 of the first close-contact protrusion 700 may be 0.1 mm, and a height h6 of the second close-contact protrusion 800 may be 0.15 mm. As the height h5 of the first close-contact protrusion 700 is greater than the height 6 of the second close-contact protrusion 800, the second gasket 420 may be bent further, and reliability of covering the end portion of the crimping part 150 may be improved. In this case, a distance d between the first close-contact protrusion 700 and the second close-contact protrusion 800 may range from 1 mm to 2 mm. When the distance d between the first close-contact protrusion 700 and the second close-contact protrusion 800 is less than 1 mm, both the first close-contact protrusion 700 and the second close-contact protrusion 800 may not bend the second gasket 420 when the crimping part 150 is crimped, and when the distance d is greater than 2 mm, the second gasket 420 may not be bent due to the large distance, and, thus, the second gasket 420 may not cover the end portion of the crimping part 150.

As described above, due to the locations and the heights of the first close-contact protrusion 700 and the second close-contact protrusion 800, the first close-contact protrusion 700 and the second close-contact protrusion 800 may serve as levers to effectively induce a lifting operation of a portion of the second gasket 420 to easily cover the end portion of the crimping part 150 when the crimping part 150 is crimped.

Although not illustrated in the drawings, the third embodiment of the present disclosure may further include the accommodation groove 500 as in the first embodiment of the present disclosure. That is, an accommodation groove 500 may accommodate the end portion of the crimping part 150, with the accommodation groove being formed in the first gasket 410 to block the end portion of the crimping part 150 from being exposed, and the second gasket 420 may be spaced apart from the upper surface of the cap assembly 300 due to the first close-contact protrusion 700 and the second close-contact protrusion 800 and cover the end portion of the crimping part 150.

According to the present disclosure, a sealing force can be increased and leakage can be prevented by a gasket disposed between a cap assembly and a crimping part. Rusting of the crimping part can be prevented by the gasket extending outward from the crimping part and covering an end portion of the crimping part when the crimping part is crimped.

According to the present disclosure, as an accommodation groove in which the end portion of the crimping part is accommodated is formed in the gasket when the crimping part is crimped, which improves the reliability of the covering the end portion of the crimping part.

According to the present disclosure, as a close-contact protrusion is disposed at a location corresponding to the end portion of the crimping part on the gasket, a lifting operation of a second gasket can be more effectively induced, thereby improving the reliability of the covering.

The effects obtainable through the present disclosure are not limited to the effects to those described herein, and other technical effects that are not mentioned will be clearly understood by those skilled in the art from the present disclosure.

While the present disclosure has been described with reference to embodiments shown in the drawings, these embodiments are merely illustrative and various modifications and equivalent other embodiments can be derived by those skilled in the art.

What is claimed is:

1. A secondary battery comprising:
a case having an opening formed therein;
an electrode assembly accommodated in the case;
a cap assembly closing the opening;
a crimping part extending from the case and surrounding the cap assembly;
a first gasket disposed between the cap assembly and the crimping part; and
a second gasket extending from the first gasket and protruding from the crimping part.

2. The secondary battery as claimed in claim 1, wherein the first gasket includes two surfaces surrounding an end portion of the cap assembly.

3. The secondary battery as claimed in claim 1, wherein the second gasket is spaced apart from the cap assembly and is in contact with an end portion of the crimping part.

4. The secondary battery as claimed in claim 3, wherein a height of the second gasket is greater than a height of the first gasket.

5. The secondary battery as claimed in claim 3, wherein the first gasket includes an accommodation groove in which the end portion of the crimping part is accommodated.

6. The secondary battery as claimed in claim 5, wherein the accommodation groove includes:
an inclined accommodation surface inclined downward from an upper surface of the first gasket and toward the second gasket; and
a vertical accommodation surface vertically extending from an end portion of the inclined accommodation surface.

7. The secondary battery as claimed in claim 5, wherein a height of the second gasket is greater than a height of the end portion of the crimping part accommodated in the accommodation groove.

8. The secondary battery as claimed in claim 3, wherein the second gasket includes a close-contact protrusion that spaces the second gasket apart from the cap assembly.

9. The secondary battery as claimed in claim 8, wherein the close-contact protrusion includes a curved surface that is in contact with the cap assembly.

10. The secondary battery as claimed in claim 8, wherein the close-contact protrusion includes:
a straight surface in contact with the cap assembly; and
an inclined surface inclined upward from the straight surface.

11. The secondary battery as claimed in claim 8, wherein the first gasket includes an accommodation groove in which the end portion of the crimping part is accommodated.

12. The secondary battery as claimed in claim 3, wherein the second gasket includes:
a first close-contact protrusion in contact with the cap assembly; and
a second close-contact protrusion that is spaced apart from the first close-contact protrusion and is in contact with the cap assembly.

13. The secondary battery as claimed in claim 12, wherein a height of the first close-contact protrusion is less than a height of the second close-contact protrusion.

14. The secondary battery as claimed in claim 12, wherein the first close-contact protrusion and the second close-contact protrusion are hemisphere shaped.

15. The secondary battery as claimed in claim 12, wherein a height of the first close-contact protrusion is 0.1 mm and a height of the second close-contact protrusion is 0.15 mm.

16. The secondary battery as claimed in claim 12, wherein a distance between the first close-contact protrusion and the second close-contact protrusion is 1 mm to 2 mm.

17. The secondary battery as claimed in claim 12, wherein the first gasket includes an accommodation groove in which the end portion of the crimping part is accommodated.

18. The secondary battery as claimed in claim 1, wherein the first gasket and the second gasket are integrally formed.

19. A battery pack comprising:
a housing;
a plurality of secondary batteries disposed in the housing; and
a busbar that connects the secondary batteries,
wherein each of the secondary batteries includes:
a case having an opening formed therein;
an electrode assembly accommodated in the case;
a cap assembly closing the opening;
a crimping part extending from the case and surrounding the cap assembly;
a first gasket disposed between the cap assembly and the crimping part; and
a second gasket extending from the first gasket and protruding from the crimping part.

20. The battery pack as claimed in claim 1, wherein the first gaskets and the second gaskets are integrally formed.
